(19) United States
(12) Patent Application Publication
(10) Pub. No.: US 2022/0274459 A1
(43) Pub. Date: Sep. 1, 2022

(54) DUAL-LAYER FLOW BLOWER UNIT FOR VEHICLE AIR-CONDITIONER

(71) Applicant: DENSO CORPORATION, Kariya-city (JP)

(72) Inventors: Keisuke TOKOROZAWA, Kariya-city (JP); Ho Yong KIM, Kariya-city (JP); Kyoung Ho KIM, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 17/747,620

(22) Filed: May 18, 2022

Related U.S. Application Data
(63) Continuation of application No. PCT/JP2020/042467, filed on Nov. 13, 2020.

(30) Foreign Application Priority Data
Nov. 21, 2019 (KR) 10-2019-0150089

(51) Int. Cl. B60H 1/00

(52) U.S. Cl. CPC B60H 1/00564; B60H 1/00028; B60H 1/00521; B60H 1/00471; B60H 2001/00614

(57) ABSTRACT

A dual-layer flow blower unit for a vehicle air-conditioner is disclosed. The blower unit has a scroll shape so as to be blown to each of a pair of an upper blower duct and a lower blower duct, and includes a pair of an upper blower case and a lower blower case which are vertically partitioned by a partition plate. The blower unit comprises a drainage case coupled to a lower part of the lower blower case and having a drainage duct formed so as to incline downward along a longitudinal direction of the lower blower duct. The blower unit includes a blower motor cooling unit that cools a blower motor by branching a part of an air blown from the lower blower duct, flowing it into an inside of a cooling chamber, and then circulating it inside a motor case.

### CROSS REFERENCE TO RELATED APPLICATIONS

The present application is a continuation application of International Patent Application No. PCT/JP2020/042467 filed on Nov. 13, 2020, which designated the U.S. and claims the benefit of priority from Patent Application No. 10-2019-0150089 filed in the Republic of Korea (KR) on Nov. 21, 2019, the entire disclosure of the above application is incorporated herein by reference.

### TECHNICAL FIELD

The disclosure of this specification relates to a dual-layer flow blower unit for a vehicle air-conditioner.

### BACKGROUND

Vehicles have air-conditioners for providing comfortable air in compartments. The air-conditioner uses a blower motor to activate a blower fan. In this case, the blower motor requires a cooling structure. Some air-conditioner uses air flow to cool the blower motor. In this arrangement, water may be introduced to the blower motor together with a cooling air. It is necessary to reduce water entering into the blower motor.

### SUMMARY

In the aforementioned viewpoint, or in other viewpoint that has not been described, further improvement is demanded for a dual-layer flow blower unit for a vehicle air-conditioner. It is an object of the disclosure of this specification to provide a new cooling structure for cooling a blower motor suit for a blower unit to generate a dual-layer flow. It is an another object of the disclosure of this specification to provide a dual-layer flow blower unit for a vehicle air-conditioner capable of preventing a large amount of water from entering a blower motor.

The disclosure of this specification provides a dual-layer flow blower unit for a vehicle air-conditioner. A dual-layer blower unit for a vehicle air-conditioner, comprising: a pair of an upper blower case and a lower blower case which are vertically partitioned by a partition plate, and has a scroll shape formed to introduce air from an air inlet formed on an upper part and formed to blow air into a pair of an upper blower duct and a lower blower duct formed in a lateral direction, respectively; an intake box which is coupled to the upper part of the upper blower case and selectively opens and closes the air inlet; a drainage case which is coupled to a lower part of the lower blower case and has a drainage duct formed so as to incline downward along a longitudinal direction of the lower blower duct; a motor case which is coupled to a lower part of the drainage case; a blower fan which is installed inside the upper blower case and the lower blower case, introduces an inside air and/or an outside air, and blows air toward each of the upper blower duct and the lower blower duct; a blower motor which is installed inside the motor case and rotates the blower fan; and a blower motor cooling unit which cools the blower motor by a cooling air, which is a part of air flowing the lower blower duct, is branched from the lower blower duct, is supplied to and passed through an inside of a cooling chamber, and is circulated inside the motor case.

In an embodiment, the dual-layer blower unit for a vehicle air-conditioner has a cooling chamber of the blower motor cooling unit. The cooling chamber of the blower motor cooling unit includes: a chamber upper plate which is extended and formed on one side of the upper blower duct connected from the upper blower case; an upper chamber which is opened at a top part and a bottom part so as to be extended and formed on one side of the lower blower duct connected from the lower blower case, an open top part being sealed by the chamber upper plate, and has a cooling inflow hole formed in a penetrating manner to branch and introduce a part of air flowing the lower blower duct; and a lower chamber which is opened at a top part so as to be extended and formed on one side of the drainage duct connected from the drainage case, an open top part being coupled to communicate with the bottom part of the upper chamber, and is communicated with an inside of the motor case through a cooling tube, the cooling tube being formed to extend vertically in the lower chamber, to penetrate a bottom wall of the lower chamber.

Further, the blower motor cooling unit further includes: a motor cooling passage which is formed to extend between one end communicated with an inside of the motor case and the other end communicated with an bottom end of the cooling tube of the lower chamber.

In a second embodiment, the dual-layer blower unit for a vehicle air-conditioner has a cooling chamber of the blower motor cooling unit. The upper chamber of the blower motor cooling unit further includes: a first bottom blocking plate which is formed to seal a bottom of the upper chamber, and is formed to have a first cooling tube insertion hole through which an upper end of the cooling tube is inserted in a penetrating manner; and a first drainage passage which is located lower than the cooling inflow hole so as to discharge water stored above the first bottom blocking plate.

In a third embodiment, the dual-layer blower unit for a vehicle air-conditioner has a cooling chamber of the blower motor cooling unit. The lower chamber of the blower motor cooling unit further includes a second drainage passage which is formed on a side wall to the drainage duct so as to discharge water stored above the bottom of the lower chamber, and wherein the cooling tube of the lower chamber is formed so that a height of an upper end of the cooling tube is formed higher than a height of an upper end of the second drainage passage.

In a fourth embodiment, the dual-layer blower unit for a vehicle air-conditioner has a cooling chamber of the blower motor cooling unit. The lower chamber of the blower motor cooling unit further includes an open side to the drainage duct which discharges water stored above the bottom of the lower chamber to the drainage duct, and wherein the cooling tube of the lower chamber is formed so that a height of an upper end of the cooling tube is formed higher than a height of an upper end of the lower chamber.

In a fifth embodiment, the dual-layer blower unit for a vehicle air-conditioner has a cooling chamber of the blower motor cooling unit. The upper chamber of the blower motor cooling unit further includes: a second bottom blocking plate which is formed to seal a bottom of the upper chamber, and is formed to have a second cooling tube insertion hole through which an upper end of the cooling tube is inserted in a penetrating manner; and a third drainage passage which is located on the second bottom blocking plate so as to discharge water stored above the second bottom blocking plate.

This disclosure provides a blower motor cooling unit with a new cooling structure for cooling a blower motor, configured to be suit for a dual-layer flow blower unit for a vehicle air-conditioner. In particular, a structure of the cooling chamber of the blower motor cooling unit is provided by the chamber upper plate, the upper chamber and the lower chamber. The cooling air for the blower motor may be supplied through the cooling inflow hole and the cooling tube formed in the cooling chamber may reduces an amount of water to the blower motor. The drainage passage, which may be provided by the first to the third drainage hole or slit, may further reduces an amount of water to the blower motor.

### BRIEF DESCRIPTION OF DRAWING

FIG. 1 is a side cross-sectional view of a vehicle air conditioner according to a comparative embodiment;

FIG. 2 is a side cross-sectional view illustrating an embodiment of a blower for a single-layer flow air conditioner of a vehicle according to a comparative example;

FIG. 3 is a perspective view illustrating an embodiment of a dual-layer flow blower unit;

FIG. 4 is an exploded perspective view of a state in which an intake box is removed in the embodiment of FIG. 3;

FIG. 5 is a plan view in which the embodiments of FIG. 4 is combined;

FIG. 6 is a cross-sectional view taken along a line VI-VI in FIG. 5;

FIG. 7 is a partially exploded perspective view of the embodiment of FIG. 4 in which only a cooling unit for a blower motor is separately illustrated;

FIG. 8 is a combined perspective view of the embodiment of FIG. 7;

FIG. 9 is a cross-sectional view illustrating a state in which a large amount of water flows into a cooling chamber and is stored in the embodiment of FIG. 6;

FIG. 10 is a cross-sectional view taken along a line VI-VI in FIG. 5;

FIG. 11 is a partially exploded perspective view of the embodiment of FIG. 10 in which only a cooling unit for a blower motor is separately illustrated;

FIG. 12 is a cross-sectional view of a third embodiment illustrating a view on a line VI-VI of FIG. 5;

FIG. 13 is a partially exploded perspective view of the embodiment of FIG. 12 in which only a cooling unit for a blower motor is separately illustrated;

FIG. 14 is an exploded perspective view of another embodiment of a dual-layer flow blower unit in a state in which an intake box is removed;

FIG. 15 is a cross-sectional view of a fourth embodiment showing a view on a line VI-VI in FIG. 5 with reference to the embodiment of FIG. 14;

FIG. 16 is a partially exploded perspective view of the embodiment of FIG. 15 in which only a cooling unit for a blower motor is separately illustrated;

FIG. 17 is a cross-sectional view of a fifth embodiment showing a view on a line VI-VI in FIG. 5 with reference to the embodiment of FIG. 14; and

FIG. 18 is a partially exploded perspective view of the embodiment of FIG. 17 in which only a cooling unit for a blower motor is separately illustrated.

### DETAILED DESCRIPTION

Hereinafter, a preferred embodiment of a dual-layer flow blower unit for a vehicle air-conditioner according to the disclosure of this specification is described in detail with reference to the accompanying drawings. Documents KR10-0759425, KR10-0745077, and KR10-0683566 discloses air-conditioners for vehicles. The disclosure in the prior art documents, KR10-0759425, KR10-0745077, and KR10-0683566 are incorporated herein by reference to explain technical elements presented herein.

People spend daily life time at roughly categorized tree categories, home, workplace, and mobile space. In particular, vehicles are most of the mobile space. Such vehicles produce moving power through engines or motors, and moves by using wheels rotated by the produced power. Vehicles includes various types such as passenger cars or SUVs and trucks for moving people and cargoes.

Not only for homes and workplaces where people live, but also for vehicles that provide mobile spaces are installed with air-conditioners to create a comfortable environment, and an air temperature, a humidity, an airflow, a ventilation, and a cleanliness must be adjusted to the optimum state according to the purpose. The air-conditioners may be called HVAC (Heating/Ventilation/Air Conditioning) which means heating, ventilation and air conditioning.

In such a vehicle air-conditioner, an outside air or an inside air blown by a blower is heat exchanged with a refrigerant passing through an evaporator and is discharged into a vehicle compartment in a cold state to cool the vehicle compartment. Alternatively, the outside air or the inside air blown by the blower is heat exchanged with a coolant water of an engine passing through a heater core and is discharged into the vehicle compartment in a warm state to warm the vehicle compartment.

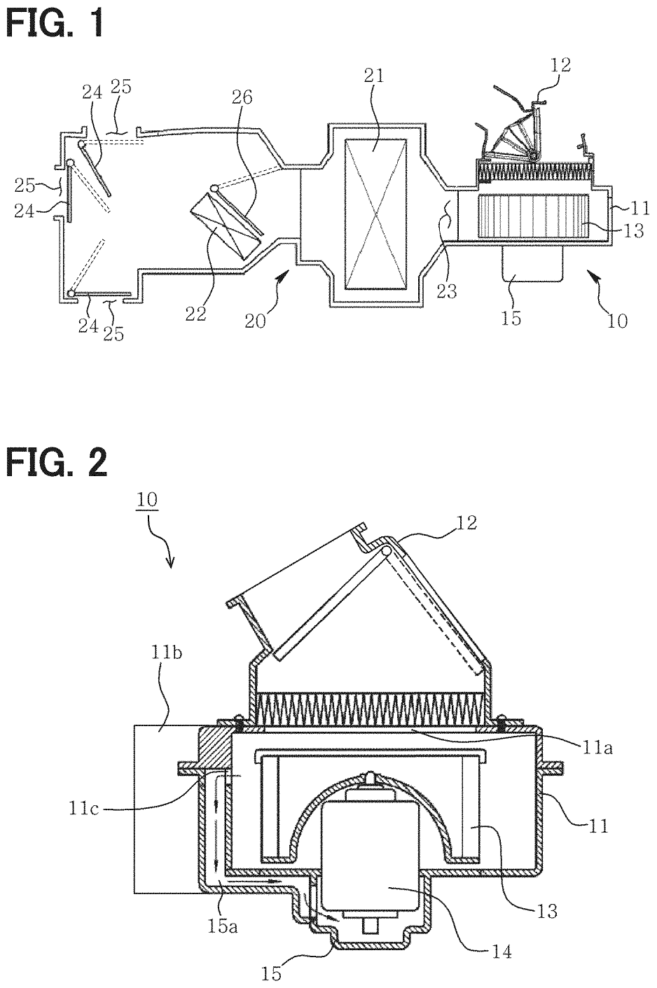

The vehicle air-conditioner as described above is large and includes a blower unit 10 and an air conditioning unit 20 as shown in FIG. 1. The blower unit 10 introduces the outside air (fresh) or the inside air (recirculate.) The air conditioning unit 20 receives air from the blower unit 10, performs heat exchange with the evaporator 21 or the heater core 22 installed inside, and then discharges air into the vehicle compartment.

The air conditioning unit 20 is formed with an air inlet 23 and a plurality of air outlet 25. The air inlet 23 is formed on an inlet side to introduce air from the blower unit 10. The air outlets 25 are formed on an outlet side and are selectively opened and closed by mode doors 24. The evaporator 21 and the heater core 22 are installed inside the air conditioning unit 20 along the air flow direction in a sequential manner. The air conditioning unit 20 has a temperature control door 26 between the evaporator 21 and the heater core 22. The temperature control door 26 adjusts a temperature of discharging air by adjusting a mixing ratio of a cold air passed through the evaporator and a hot air passed through the heater core 22.

As shown in FIG. 2, the blower unit 10 has a blower case 11, an intake box 12, a blower fan 13 and a blower motor 14. The blower case 11 has a scroll shape which is formed to introduce an inside air and/or an outside air from an air inlet 11a formed at an upper part and is formed to blow to a blower duct 11b formed in a lateral direction. The intake box 12 coupled to the upper part of the blower case 11 at the air inlet 11a. The intake box 12 has an intake door selectively opens and closes an outside intake and an inside intake. The blower fan 13 sucks air from the outside intake or the inside intake, and blows air towards the blower duct 11b. The blower motor 14 rotates the blower fan 13.

The blower case 11 forms a cooling passage 15a to cool the blower motor 14. The blower case 11 has a cooling hole 11c, a cooling inlet, which is formed on one side surface of the blower duct 11b. A part of air blown to the blower duct 11b is branched into the cooling passage 15a, flows through the cooling passage 15a and flows over a part of the blower motor 14. A part of air in the cooling passage 15a flows in a recirculating manner. Here, the blower motor 14 is supported and protected by a motor case 15. The motor case 15 is coupled to a lower part of the blower case 11 to form the cooling passage 15a. The cooling passage 15a communicates the cooling hole 11c and the blower motor 14.

The above-mentioned explanation about the air-conditioner for a vehicle is related to the blower unit for a single-layer flow blower unit for an air-conditioner for the vehicle. In this single-layer arrangement, only the outside air is supplied to the compartment, a load of a compressor becomes large and a fuel loss is large. Only the inside air is supplied to the vehicle compartment, air in the vehicle compartment may be contaminated. Especially in a cold season, in the winter, it is hard to remove fog on a windshield by using the inside air in a recirculating manner. Contrary, a low temperature outside air lowers heating performance.

In order to eliminate such a disadvantage, a dual-layer flow blower unit for a vehicle air-conditioner is proposed, which is capable of blowing into a vehicle compartment in a separating manner or a mixing manner of the inside air and the outside air. For example, KR10-0759425B discloses an air conditioning unit for a vehicle and KR10-0745077B discloses a dual-layer flow type air-conditioner for a vehicle. Such a dual-layer flow blower unit for a vehicle air-conditioner is configured to generate an upper and lower dual-layer flow by a blower fan 13 in the following ways. First, two blower fans 13 are disposed in an upper space and a lower space, respectively, which are provided by vertically dividing a flow path of a blower case 11 and an air-conditioner unit 20 by a partition wall. Second, even if a single blower fan 13 is disposed, independent inside air inlets are provided to enable the dual-layer flow.

In the first case of the above-mentioned dual-layer flow blower unit for a vehicle air-conditioner, two blower fans 13 are disposed in the blower device 10, a size of the device becomes large and a space utilization is reduced. In the second case of the above-mentioned dual-layer blower unit for a vehicle air-conditioner, one blower fan 13 and dedicated inside air inlets are formed, there may be a problem of an increased manufacturing cost due to a manufacturing difficulty caused by a complicated configuration. In order to solve such a problem, KR10-0683566B discloses a blower unit of an air-conditioner for a vehicle. In this arrangement, an intake box 12 is configured to introduce the outside and inside air. A guide member is configured to flow the inside air and the outside air in a separated manner to an upper side and a lower side of a blower fan 13.

There is a demand for a cooling structure for cooling the blower motor 14 for rotating the blower fan 13. In particular, there is a demand for a cooling structure suitable for a dual-layer flow blower unit for a vehicle air-conditioner. Further, if the cooling hole 11c is simply formed and communicated with the cooling passage 15a of the motor case 15, a large amount of water such as rainwater may enter together with the outside air. In this specification, the term water is described as a representative of liquids, and water includes liquids such as beverages and cooling water. Water is a typical example of the liquid to be contrasted with the gas, the air, to be handled by the blower 10.

The embodiment provides a new cooling structure for cooling a blower motor suit for a blower unit to generate a dual-layer flow for a vehicle air-conditioner. In particular, it provides a dual-layer flow blower unit for a vehicle air-conditioner capable of preventing a large amount of water from entering a blower motor.

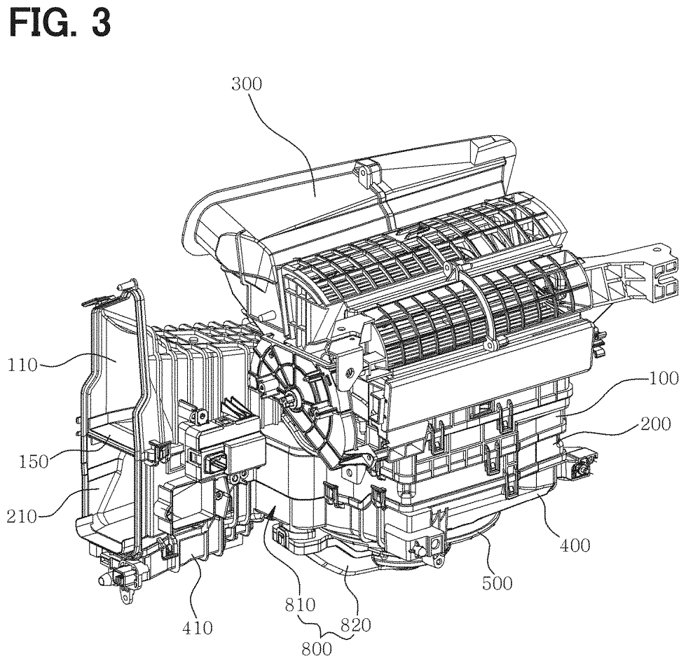

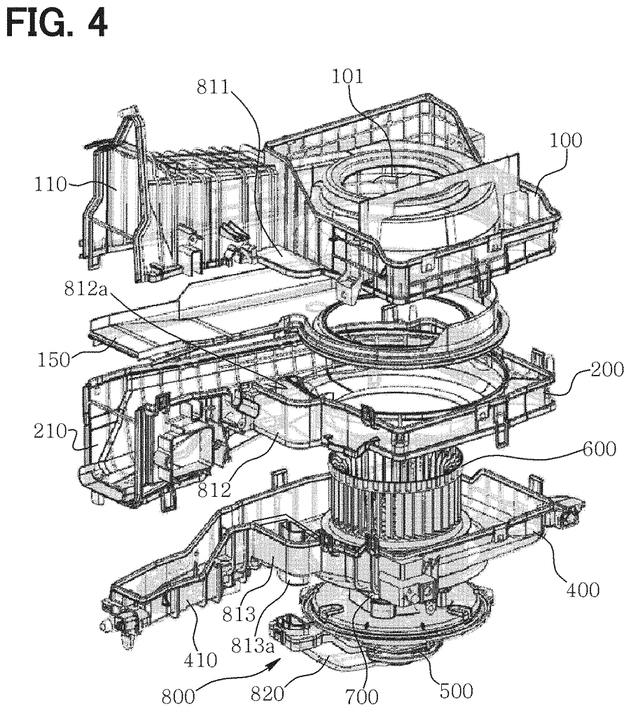

As shown in FIGS. 3 and 4, the dual-layer flow blower unit for a vehicle air-conditioner includes an upper blower case 100, a lower blower case 200, an intake box 300, a drainage case 400, a motor case 500, a blower fan 600, a blower motor 700 and a blower motor cooling unit 800.

The dual-layer flow blower unit for a vehicle air-conditioner has a scroll shape which is vertically partitioned by a partition plate 150. The upper blower case 100 and the lower blower case 200 form a pair. The upper blower case 100 and the lower blower case 200 introduces the inside air and the outside air through an air inlet 101. the introduced air is blown into the upper blower duct 110 and the lower blower duct 120, respectively. That is, the upper blower case 100 on an upper side and the lower blower case 200 on a lower side are vertically partitioned and vertically coupled with respect to the partition plate 150 on an intermediate location.

The upper blower duct 110 is formed on a side, an downstream end, of the upper blower case 100. The lower blower duct 210 is formed on a side, an downstream end, of the lower blower case 200. The introduces air, the inside air and the outside air, is blown through the upper blower duct 110 and the lower blower duct 210, respectively. The upper blower duct 110 and the lower blower duct 210 form and provide a dual-layer flow, and the inside air and the outside air blown by forming the dual-layer flow in this way passes through the air conditioning unit and becomes cold or warm air and are discharged into the vehicle compartment. The air conditioning unit for the dual-layer flow air-conditioner for a vehicle has a more complicated configuration than an air-conditioning unit for the single-layer flow air-conditioner shown in FIG. 1, and is widely known, so detailed description thereof is omitted.

The intake box 300 is coupled to the upper part of the upper blower case 100 as shown in FIG. 3. The intake box 300 selectively opens and closes the air inlet 101. That is, the intake box 300 is coupled to the air inlet 101 formed in the upper part of the upper blower case 100. The intake box 300 controls and adjusts an intake air ratio. For example, the intake box 300 may enable a 100% of the inside air, a 100% of the outside air, or a mixed air including both the inside air and the outside air. The intake box 300 also has various structures for controlling the intake air ratio, so detailed description thereof is omitted.

As shown in FIG. 3 and FIG. 4, the drainage case 400 is coupled to the lower blower case 200. The drainage case 400 has a drainage duct 410 formed so as to incline downward along a longitudinal direction of the lower blower duct 210. The drainage case 400 is configured, through the drainage duct 410, to drain water which is contained in the inside air or the outside air flowing in from the air inlet 101.

The inside air and/or the outside air introduced into the air inlet 101 is forcibly blown to the upper blower duct 110 and the lower blower duct 210 by rotating the blower fan 600 described later. At this time, water contained in the inside air and/or the outside air attaches on and flows down along an inside walls of the upper blower case 100 and the lower blower case 200 due to the centrifugal force generated by a rotation of the blower fan 600. Water on the inside walls may be collected in the drainage case 400, and is drained through the drainage duct 410. In particular, the drainage duct 410 of the drainage case 400 may also have a function of draining water collected and stored in the cooling chamber 810 of the blower motor cooling unit 800, which will be described later.

The motor case 500 is coupled to the lower part of the drainage case 400 as shown in FIGS. 3 and 4. The motor case 500 as described by it's name, in which the blower motor 700 is installed, is a configuration for protecting the blower motor 700, which is described later.

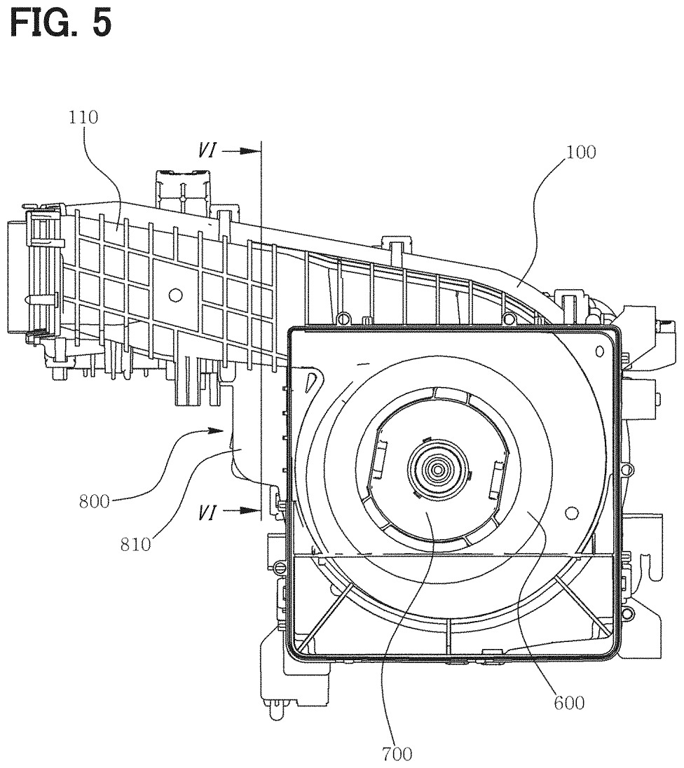

As shown in FIGS. 4 and 5, the blower fan 600 is installed inside the upper blower case 100 and the lower blower case 200. The blower fan 600 introduces the inside air and/or the outside air, and then blows air toward each of the upper blower duct 110 and the lower blower duct 210. That is, when the inside air and/or the outside air is sucked into the air inlet 101 by controlling an intake ratio of the inside air and the outside air through the intake box 300, the inside air and/or the outside air sucked by the rotating blower fan 600 is forcibly blown toward each of the upper air duct 110 and the lower air duct 210. At this time, the blower fan 600 is a bidirectional suction type centrifugal multi-blade fan. The blower fan 600 includes a central hub and surrounding blade portions. The blade portions are divided into upper portions and lower portions to form the dual-layer flow. The blower fan 600 divides the introduced air in two flows and blows separately into each of the upper blower duct 110 and the lower blower duct 210.

The blower motor 700 is installed inside the motor case 500 as shown in FIGS. 4 and 5. The blower motor 700 rotates the blower fan 600. The blower motor 700 is an electric motor that rotates by applying an electric power. The blower motor 700 may become high temperature at high speed rotation, such as a high load, at a power cooling and a power heating. Therefore, the blower motor 700 needs a configuration to lower the high temperature. For this purpose, the blower motor cooling unit 800 is installed.

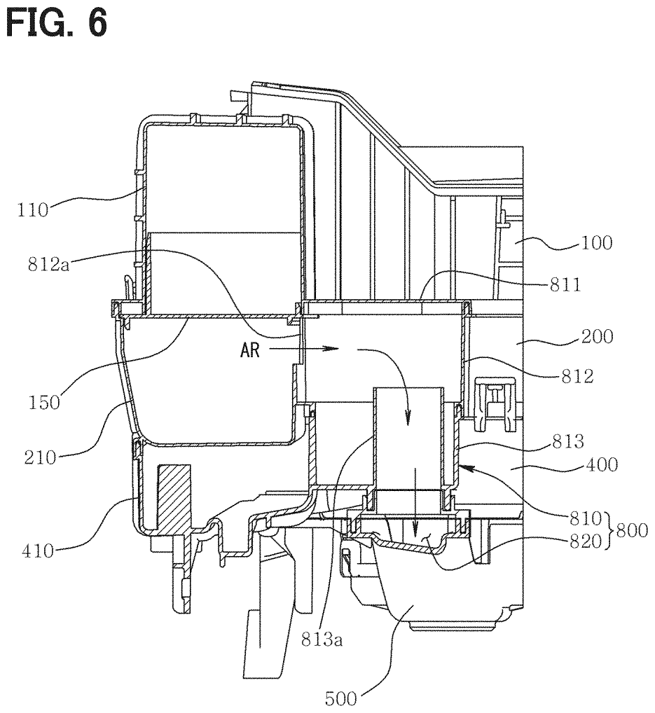

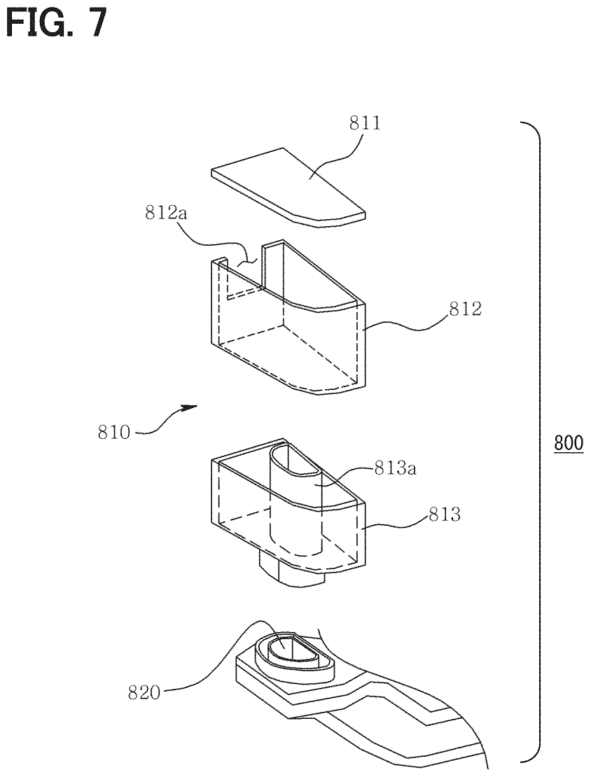

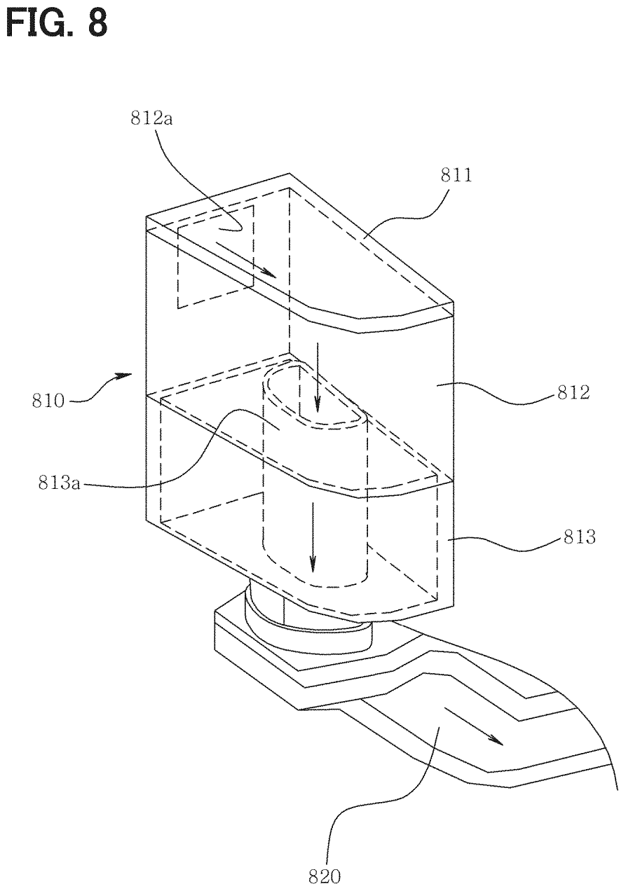

As shown in FIGS. 3 to 8, the blower motor cooling unit 800 cools the blower motor 700 by a cooling air. The cooling air is a part of air flowing in the lower blower duct 210. The cooling air is branched from the lower blower duct 210, is supplied to and passed through an inside of a cooling chamber 810, and is circulated inside the motor case 500. The cooling air enters into the cooling chamber 810 and flows through an inside of the cooling chamber 810. After flowing the cooling chamber 810, the cooling air enters the cooling tube 813a and flows through the cooling tube 813a. After flowing the cooling tube 813a, the cooling air enters an inside of the motor case 500 and flows the inside of the motor case 500. The blower motor cooling unit 800 in the dual-layer flow blower unit for the vehicle air-conditioner includes a cooling chamber 810 and a motor cooling flow path 820.

First, the cooling chamber 810 includes an upper chamber 812 and a lower chamber 813 providing two layers of chambers. The cooling chamber 810 is a cup shaped main member and a chamber upper plate 811 which covers an upper opening of the cup shaped main member. The chamber upper plate 811 corresponds to a ceiling of the cooling chamber 810. The chamber upper plate 811 is extended and formed on one side (inner side) of the upper blower duct 110 connected from the upper blower case 100. The upper chamber 812 is opened at a top part and a bottom part so as to be extended and formed on one side of the lower blower duct 210 connected from the lower blower case 200. The opened upper part of the upper chamber 812 is sealed by the chamber upper plate 811. An cooling inflow hole 812a is formed on an inner wall of the lower blower case 200 in a penetrating manner. The cooling inflow hole 812a communicates air in the lower blower duct 210 and air in the upper chamber 812. The cooling inflow hole 812a branches a part of air flowing through the lower blower duct 210 into the upper chamber 812. As a result, the cooling inflow hole 812a enables air flow through the upper chamber 812. The lower chamber 813 is extended and formed on one side (inner side) of the drainage duct connected from the drainage case 400. A top part of the lower chamber 813 is opened and is coupled to communicate with a bottom part of the upper chamber 812. The lower chamber 813 has the cooling tube 813a. The cooling tube 813a is located inside of the lower chamber 813. The lower chamber 813 is communicated with an inside of the motor case 500 through the cooling tube 813a. The cooling tube 813a is formed to extend vertically in the lower chamber 813. The cooling tube 813a extends in an upright manner. The cooling tube 813a is formed to penetrate a bottom wall of the lower chamber 813.

Therefore, the inside air and/or the outside air sucked into the air inlet 101 is blown toward each of the upper blower duct 110 and the lower blower duct 210 by rotating the blower fan 600. A part of air flowing through the lower blower duct 210 branches and enters into the cooling inflow hole 812a and flows through an inside of the upper chamber 812. Air entering through the cooling inflow hole 812a flows and is circulated inside the motor case 500 via the cooling tube 813a of the lower chamber 813. Air cools the blower motor 700 installed inside the motor case 500 down. Then, air returns into the lower blower duct 210 through the blower motor 700 by rotating the blower fan 600. Returned air again flows through the lower blower duct 210.

The motor case 500 forms and defines the motor cooling passage 820 which enables air flow through the motor case 500. Air introduced through the cooling inflow hole 812a flows through the upper chamber 812, then enters and flows through the cooling tube 813a, and then flows through the motor cooling passage 820 formed in the motor case 500. The motor cooling passage 820 is formed to extend between one end communicated with an inside of the motor case 500 and the other end communicated with an bottom end of the cooling tube 813a of the lower chamber 813. The motor cooling passage 820 extends to communicate an inside of the motor case 500 and a downstream end of the cooling tube 813a. One end of the motor cooling passage 820 is coupled to the downstream end of the cooling tube 813a. The other end of the motor cooling passage 820 is coupled to the inside of the motor case 500. Therefore, air entered through the cooling inflow hole 812a flows to pass through an inside of the upper chamber 812, and to pass through an inside of the lower chamber 813 at least partially. Then, air enters and flows through the cooling tube 813a. After passing through the cooling tube 813a, air enters and flows the motor cooling passage 820 in the motor case 500. As a result, air circulates through the motor cooling passage 820.

There are at least two reasons why the cooling chamber 810 includes the upper chamber 812, the lower chamber 813, and the cooling tube 813a. The cooling tube 813a protrudes into at least a full height of the lower chamber 813 from a bottom of the lower chamber 813. The cooling tube 813a may protrudes into at least a part of the upper chamber 812. First, in order to keep and delay sufficient time to hold and reserves a predetermined amount of water in the cooling chamber 810. Second, it is necessary to provide both a height of the cooling tube 813a from the bottom of the lower chamber 813 and a height location of the cooling inflow hole 812a to keep a smooth air flow to the motor case 500.

That is, since the cooling tube 813a is formed upright in the lower chamber 813, even if the water contained in the air flowing in through the cooling inflow hole 812a is gradually collected and stored in a bottom of the lower chamber 813. There may be certain long time for filling up to the full height of the cooling tube 813a. Water level may be lowered or disappeared due to be discharged through a gap between members or be evaporated gradually.

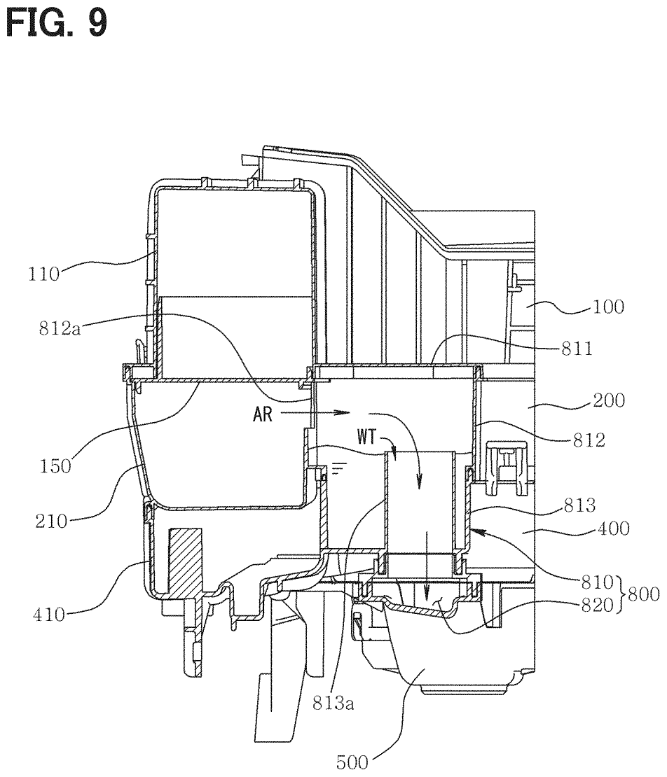

The structure of the first embodiment of the blower motor cooling unit 800 in the dual-layer flow blower unit for the vehicle air-conditioner may perform sufficiently cooling and water preventing effect of the blower motor 700. The cooling chamber 810 can accumulate an amount of water (WT) up to the height of the cooling tube 813a as shown in FIG. 9. However, in rainy weather, a large amount of water may continuously enter, stored amount of water (WT) may reach the height of the cooling tube 813a, and may enter into the motor case 500 through the motor cooling passage 820. Water (WT) may exist in various forms such as an amount of water, droplets of water and a vapor of water. If the water enters the motor cooling passage 820, and if a large amount of water suddenly flows and fills the inside of the motor case 500, the blower motor 700 may be stopped or be short circuit.

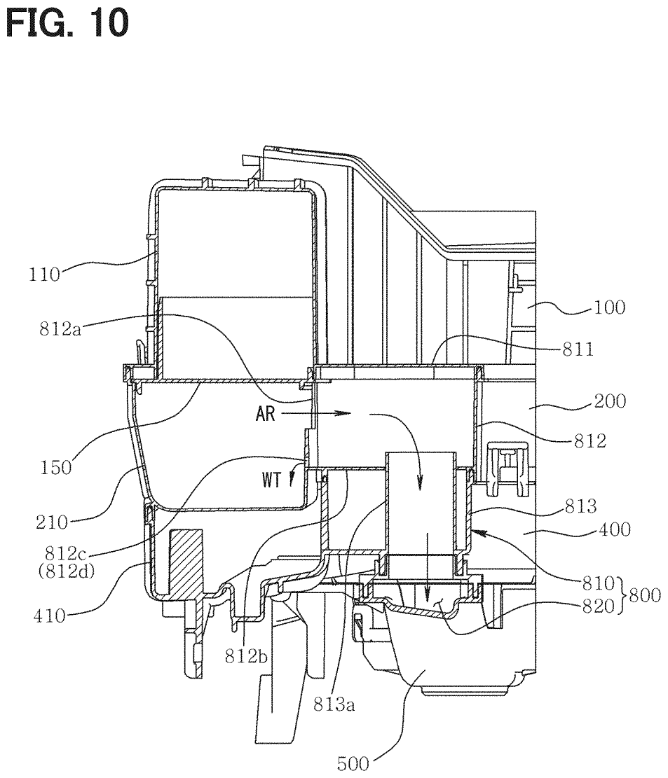

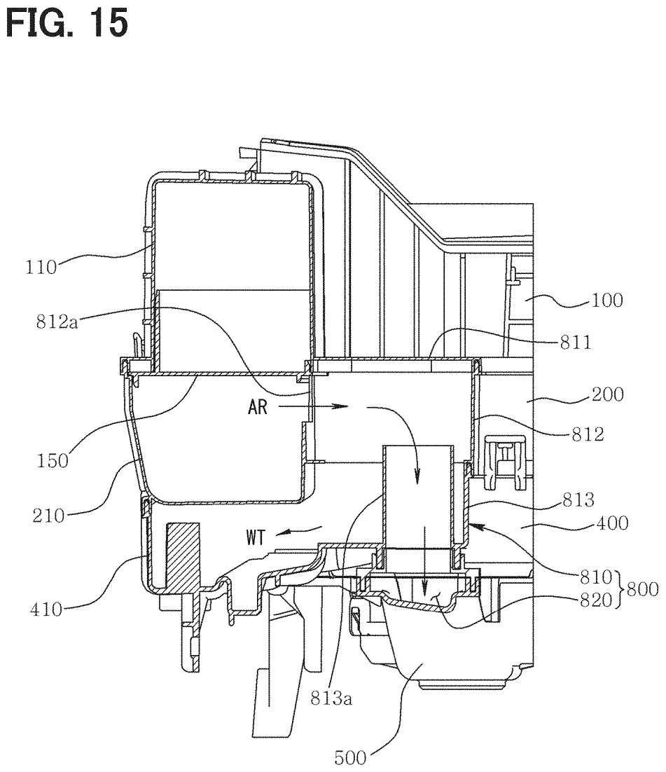

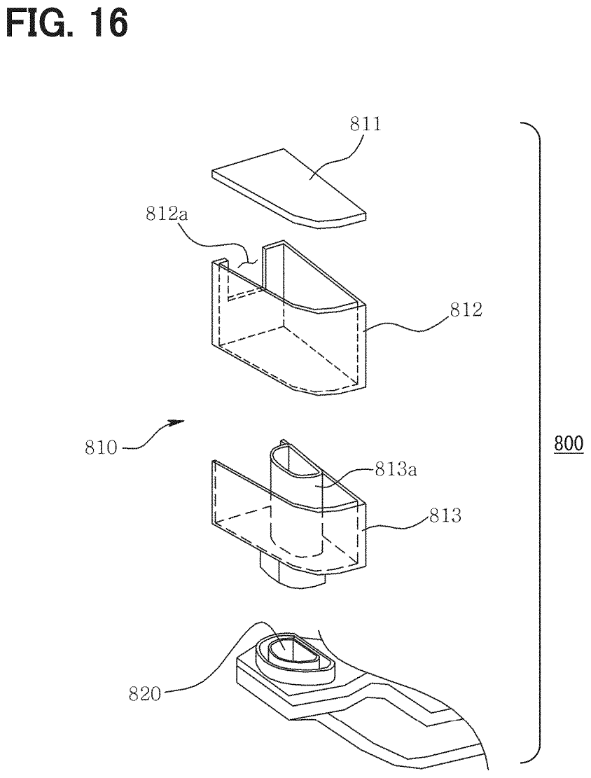

A second to fifth embodiments of the blower motor cooling unit 800 in the dual-layer flow blower unit for the vehicle air-conditioner as shown in FIGS. 10 to 18, which are provided to solve the problem under such a special situation, are described.

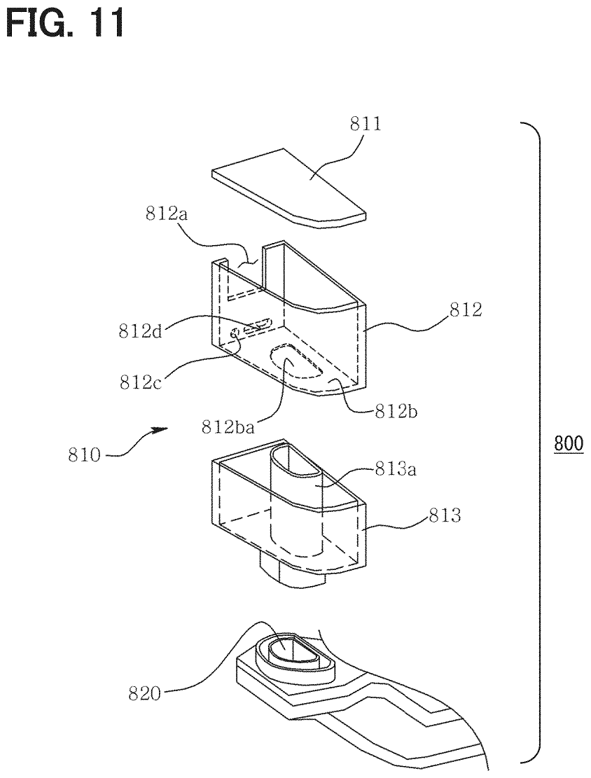

As shown in FIGS. 10 and 11, the second embodiment of the blower motor cooling unit 800 solves the above problem through a structural change of the upper chamber 812 with a similar configuration as the first embodiment described above. In this arrangement, the upper chamber 812 is formed with a first bottom blocking plate 812b. The first bottom blocking plate 812b is formed to cover and seal a bottom of the upper chamber 812. The first bottom blocking plate 812b is formed to have a first cooling tube insertion hole 812ba through which the cooling tube 813a is inserted. The first cooling tube insertion hole 812ba is formed in a penetrating manner on the first bottom blocking plate 812b. An upper part of the cooling tube 813a is inserted into the first cooling tube insertion hole 812ba in a sealed manner. The upper part of the cooling tube 813a protrudes upwardly from the first bottom blocking plate 812b. A cavity defined on the first bottom blocking plate 812b may collect and stores water. A wall between the lower blower duct 210 and the upper chamber 812 has a first drainage passage formed in a penetrating manner. In a vertical direction, a location of the first drainage passage opens lower than the cooling inflow hole 812a. A top end of the first drainage passage is lower than a bottom of the cooling inflow hole 812a. A bottom end of the first drainage passage is almost the same as the first bottom blocking plate 812b. The first drainage passage may be provided by a first drainage hole 812c or a first drainage slit 812d. The first drainage passage discharges water stored above the first bottom blocking plate 812b to the lower blower duct 210. The first drainage passage discharges water from the upper chamber 812 to the lower blower duct 210.

Therefore, air flowing through the cooling inflow hole 812a of the upper chamber 812 circulates inside the motor case 500 through the motor cooling passage 820 via the cooling tube 813a. Water may be stored above the first bottom blocking plate 812b of the upper chamber 812. Water may be discharged to the lower blower duct 210 through the first drainage passage such as the first drainage hole 812c or the first drainage slit 812d. As a result, no water may be stored in the cooling chamber 810.

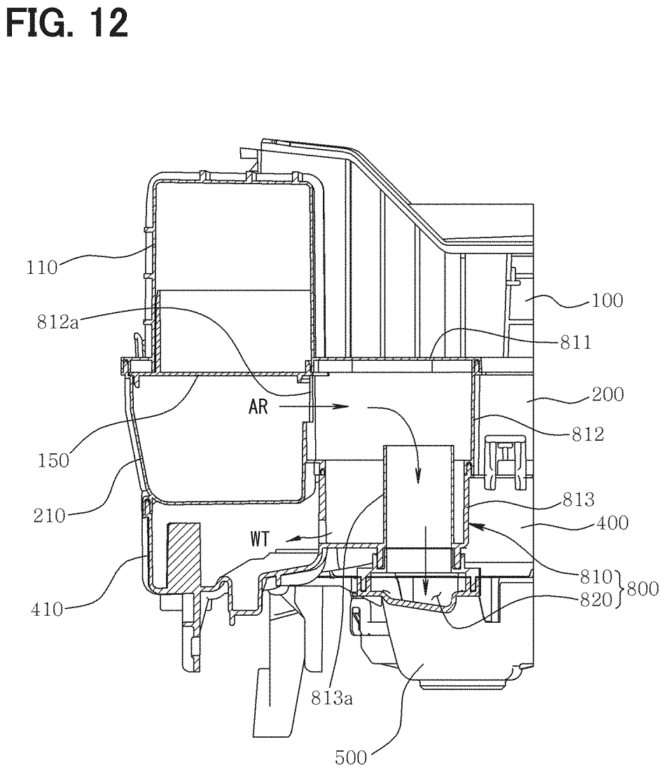

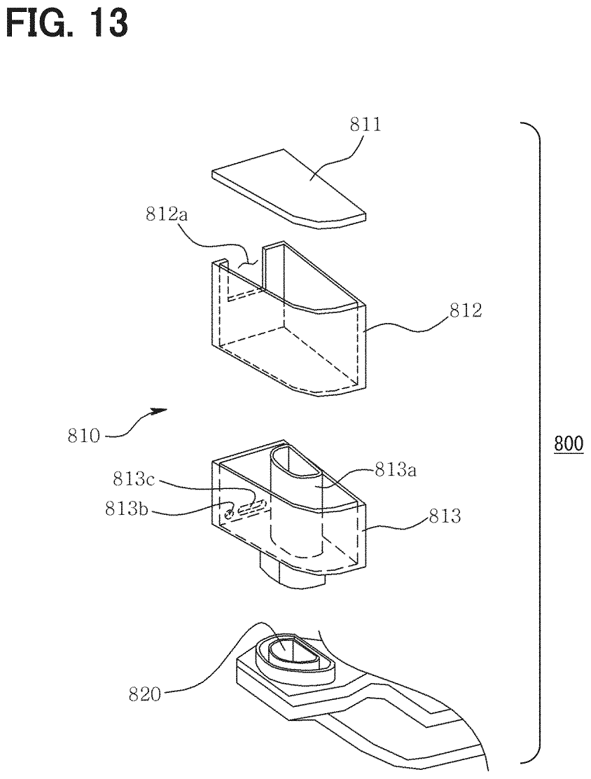

However, in this case, water may enters the cooing tube 813a, since a difference between a bottom surface of the upper chamber 812 and a top end of the cooling tube 813a is small. Certain amount of water may be accidentally enters the cooling tube 813a due to a movement of the vehicle on a sloping road. In this arrangement, airflow entering the first drainage passage such as the first drainage hole 812c or the first drainage slit 812d from the lower blower duct 210 may hinder a water drain flow. In order to solve this, a third embodiment of the blower motor cooling unit 800 is presented as shown in FIGS. 12 and 13.

First, as shown in FIGS. 12 and 13, the third embodiment of the blower motor cooling unit 800 solves the above problem through a structural change of the upper chamber 812 by using a similar configuration as the first embodiment described above. In this embodiment, a wall between the lower chamber 813 and the drainage duct 410 has a second drainage passage formed in a penetrating manner. The second drainage passage is formed on a wall between the lower blower duct 210 and the lower chamber 813. The second drainage passage discharges water stored above the bottom to the lower blower duct 210. The second drainage passage may be provided by a second drainage hole 813c or a second drainage slit 813d. In this arrangement, the cooling tube 813a of the lower chamber 813 must be formed so that a height of an upper end of the cooling tube 813a is at least higher than a height of an upper end of the second drainage passage such as the second drain hole 813b or the second drain slit 813c.

Therefore, air flowing through the cooling inflow hole 812a of the upper chamber 812 circulates inside the motor case 500 through the motor cooling passage 820 via the cooling tube 813a. Water may be stored above a bottom of the lower chamber 813. Water may be discharged to the drainage duct 410 through the second drainage passage such as the second drainage hole 813c or the second drainage slit 813d. As a result, no water may be stored in the cooling chamber 810.

Further, in the third embodiment of the blower motor cooling unit 800, the height of the upper end of the cooling tube 813a can be formed sufficiently high. Therefore, there is no possibility that water flows into the cooling tube 813a even when the vehicle moves on a sloped road. Air enters exclusively from the lower blower duct 210 passed through the cooling inflow hole 812a, the circulation of air for cooling the blower motor 700 also becomes smooth.

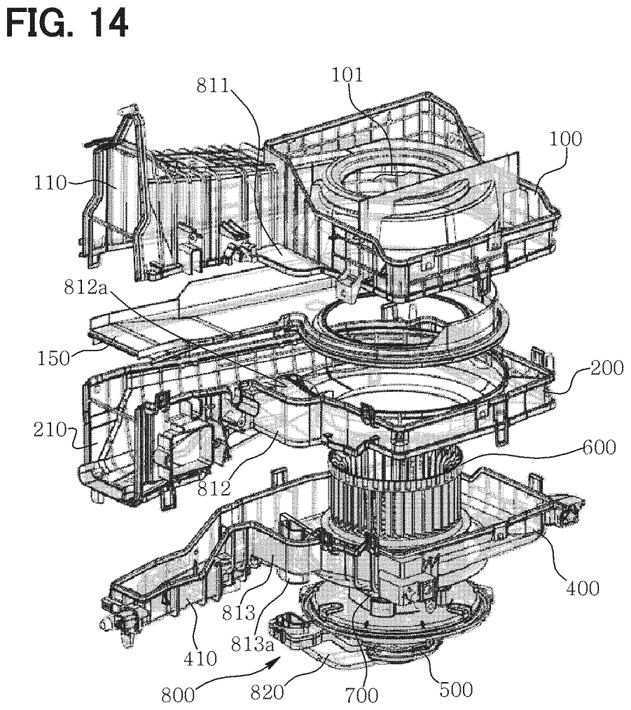

On the other hand, the fourth embodiment, which is a further extension of the third embodiment of the blower motor cooling unit 800, is referred to with reference to FIGS. 14 to 16. In this embodiment, a wall between the lower chamber 813 and the drainage duct 410 has a drainage passage formed in a penetrating manner. The drainage passage is formed by provide an open side. There is no side wall. The open side discharges water stored above the bottom of the lower chamber 813 to the drainage duct 410. The drainage passage is provided by the open side which is formed by removing a side wall. In this arrangement, the cooling tube 813a of the lower chamber 813 must be formed so that a height of an upper end of the cooling tube 813a is at least higher than a height of an upper end of the lower chamber 813.

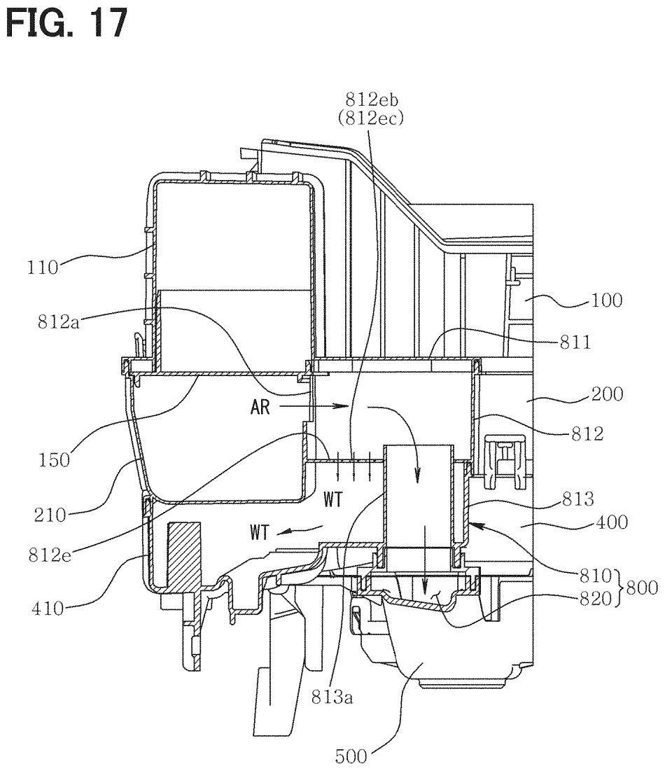

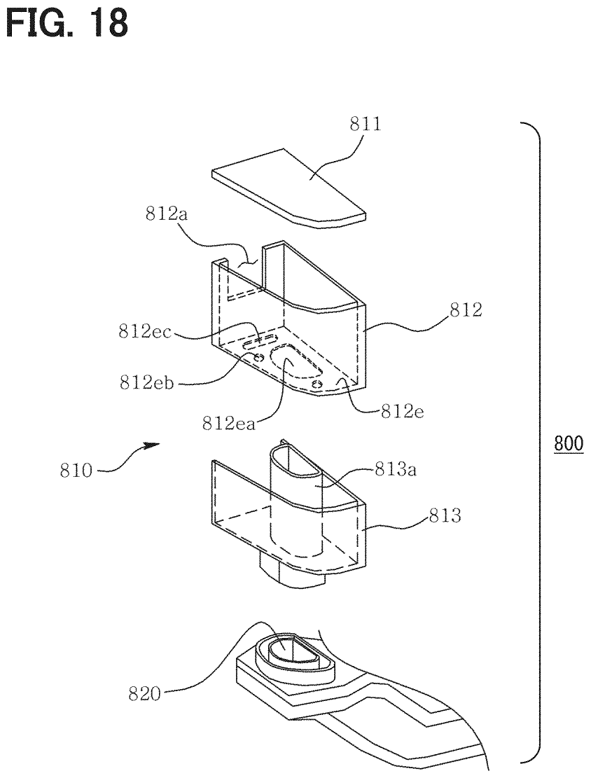

In the fourth embodiment of such a blower motor cooling unit 800, a side surface is completely opened as compared with the third embodiment. In the case of the fourth embodiment, no water may be collected and stored in the cooling chamber 810. Air flowing in through the cooling inflow hole 812a may also easily escape to the drainage duct 410 through the side opening. As a result, the cooling efficiency of the blower motor 700 may drop. In order to solve this, a fifth embodiment of the blower motor cooling unit 800 is presented as shown in FIGS. 17 and 18.

As shown in FIGS. 17 and 18, the fifth embodiment of the blower motor cooling unit 800 solves the above problem through a structural change of the upper chamber 812 by using a similar configuration as the fourth embodiment described above. In this arrangement, the upper chamber 812 is formed with a second bottom blocking plate 812e which covers and seals a bottom of the upper chamber 812. The second bottom blocking plate 812e has a second cooling tube insertion hole 812ea where the cooling tube 813a is inserted. The first cooling tube insertion hole 812ba is formed in a penetrating manner on the first bottom blocking plate 812b. The cooling tube 813a is inserted into the second cooling tube insertion hole 812ea in a sealed manner. A part of the cooling tube 813a protrudes upwardly from the second bottom blocking plate 812e. A cavity defined on the second bottom blocking plate 812e may collect and stores water. A second bottom blocking plate 812e has a third drainage passage formed in a penetrating manner. The third drainage passage discharges water stored above the second bottom blocking plate 812e. The third drainage passage may be provided by a third drainage hole 812eb or a third drainage slit 812ec. The third drainage passage discharges water from the upper chamber 812 to the lower camber 813.

Therefore, air flowing through the cooling inflow hole 812a of the upper chamber 812 circulates inside the motor case 500 through the motor cooling passage 820 via the cooling tube 813a. Water may be stored above a bottom of the upper chamber 812. Water may be discharged to the lower chamber 813 through the third drainage passage such as the third drainage hole 813eb or the third drainage slit 813ec in a gravity direction. As a result, no water may be stored in the cooling chamber 810. At this time, there is the lower chamber 813 below the second bottom blocking plate 812e. Water discharged downward through the third drainage hole 812eb or the third drainage slit 812ec of the second bottom blocking plate 812e is discharged through a widely opened side portion of the lower chamber 813. Water is discharged to the drainage duct 410 through the side surface, no water is stored inside the cooling chamber 810.

Further, in the fifth embodiment of the blower motor cooling unit 800, no water is stored above the second bottom blocking plate 812e. Water is always discharged downward through the third drainage passage such as the third drainage hole 812eb or the third drainage slit 812ec. There is no risk of water flowing into the cooling tube 813a. Air flowing in from the lower blower duct 210 is also blocked by the second lower bottom blocking plate 812e, and most of air flows into the cooling tube 813a. As a result, air circulation to cool the blower motor 700 is smoothly performed.

The dual-layer flow blower unit for the vehicle air-conditioner provides the blower motor cooling unit 800 having a new cooling structure for cooling the blower motor suit for the blower unit to generate a dual-layer flow for the vehicle air-conditioner. In particular, a structure of the cooling chamber 810 of the blower motor cooling unit 800 is provided by the chamber upper plate 811, the upper chamber 812 and the lower chamber 813. The cooling air for the blower motor may be supplied through the cooling inflow hole 812a and the cooling tube 813a formed in the cooling chamber 810 may reduces an amount of water to the blower motor 700. The drainage passage, which may be provided by the first to the third drainage hole or slit, may further reduces an amount of water to the blower motor 700.

The embodiments should not be construed as limiting the disclosed technical ideas. The scope of protection of disclosure is limited only by the matters stated in the claims, and a person having ordinary knowledge in the technical field of disclosure can improve and change the technical idea into various forms. Therefore, such improvements and changes should fall within the scope of the disclosure as long as they are obvious to those with ordinary knowledge.

What is claimed is:

1. A dual-layer flow blower unit for a vehicle air-conditioner, comprising:
a pair of an upper blower case and a lower blower case which are vertically partitioned by a partition plate, and has a scroll shape formed to introduce air from an air inlet formed on an upper part and formed to blow air into a pair of an upper blower duct and a lower blower duct formed in a lateral direction, respectively;
an intake box which is coupled to the upper part of the upper blower case and selectively opens and closes the air inlet;
a drainage case which is coupled to a lower part of the lower blower case and has a drainage duct formed so as to incline downward along a longitudinal direction of the lower blower duct;
a motor case which is coupled to a lower part of the drainage case;
a blower fan which is installed inside the upper blower case and the lower blower case, introduces an inside air and/or an outside air, and blows air toward each of the upper blower duct and the lower blower duct;
a blower motor which is installed inside the motor case and rotates the blower fan; and
a blower motor cooling unit which cools the blower motor by a cooling air, which is a part of air flowing the lower blower duct, is branched from the lower blower duct, is supplied to and passed through an inside of a cooling chamber, and is circulated inside the motor case, wherein
the cooling chamber of the blower motor cooling unit includes:
a chamber upper plate which is extended and formed on one side of the upper blower duct connected from the upper blower case;
an upper chamber which is opened at a top part and a bottom part so as to be extended and formed on one side of the lower blower duct connected from the lower blower case, an open top part being sealed by the chamber upper plate, and has a cooling inflow hole formed in a penetrating manner to branch and introduce a part of air flowing the lower blower duct; and
a lower chamber which is opened at a top part so as to be extended and formed on one side of the drainage duct connected from the drainage case, an open top part being coupled to communicate with the bottom part of the upper chamber, and is communicated with an inside of the motor case through a cooling tube, the cooling tube being formed to extend vertically in the lower chamber, to penetrate a bottom wall of the lower chamber, and wherein
the upper chamber further includes:
a first bottom blocking plate which is formed to seal a bottom of the upper chamber, and is formed to have a first cooling tube insertion hole through which an upper end of the cooling tube is inserted in a penetrating manner; and
a first drainage passage which is located lower than the cooling inflow hole so as to discharge water stored above the first bottom blocking plate.

2. A dual-layer flow blower unit for a vehicle air-conditioner, comprising:
a pair of an upper blower case and a lower blower case which are vertically partitioned by a partition plate, and has a scroll shape formed to introduce air from an air inlet formed on an upper part and formed to blow air into a pair of an upper blower duct and a lower blower duct formed in a lateral direction, respectively;
an intake box which is coupled to the upper part of the upper blower case and selectively opens and closes the air inlet;
a drainage case which is coupled to a lower part of the lower blower case and has a drainage duct formed so as to incline downward along a longitudinal direction of the lower blower duct;
a motor case which is coupled to a lower part of the drainage case;
a blower fan which is installed inside the upper blower case and the lower blower case, introduces an inside air and/or an outside air, and blows air toward each of the upper blower duct and the lower blower duct;
a blower motor which is installed inside the motor case and rotates the blower fan; and
a blower motor cooling unit which cools the blower motor by a cooling air, which is a part of air flowing the lower blower duct, is branched from the lower blower duct, is supplied to and passed through an inside of a cooling chamber, and is circulated inside the motor case, wherein
the cooling chamber of the blower motor cooling unit includes:
a chamber upper plate which is extended and formed on one side of the upper blower duct connected from the upper blower case;
an upper chamber which is opened at a top part and a bottom part so as to be extended and formed on one side of the lower blower duct connected from the lower blower case, an open top part being sealed by the chamber upper plate, and has a cooling inflow hole formed in a penetrating manner to branch and introduce a part of air flowing the lower blower duct; and
a lower chamber which is opened at a top part so as to be extended and formed on one side of the drainage duct connected from the drainage case, an open top part being coupled to communicate with the bottom part of the upper chamber, and is communicated with an inside of the motor case through a cooling tube, the cooling tube being formed to extend vertically in the lower chamber, to penetrate a bottom wall of the lower chamber, and wherein
the lower chamber further includes
an open side to the drainage duct which discharges water stored above the bottom of the lower chamber to the drainage duct, and wherein
the cooling tube of the lower chamber is formed so that a height of an upper end of the cooling tube is formed higher than a height of an upper end of the lower chamber, and wherein
the upper chamber further includes:
a second bottom blocking plate which is formed to seal a bottom of the upper chamber, and is formed to have a second cooling tube insertion hole through which an upper end of the cooling tube is inserted in a penetrating manner; and
a third drainage passage which is located on the second bottom blocking plate so as to discharge water stored above the second bottom blocking plate.
